(19) United States
(12) Patent Application Publication
(10) Pub. No.: US 2006/0279647 A1
(43) Pub. Date: Dec. 14, 2006

(54) Multi-spectral image capturing apparatus and adapter lens

(75) Inventors: Toru Wada, Niiza-shi (JP); Yasuhiro Komiya, Hino-shi (JP); Takeyuki Ajito, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/509,537

(22) Filed: Aug. 24, 2006

Related U.S. Application Data
(63) Continuation of application No. PCT/JP05/04130, filed on Mar. 9, 2005.

(30) Foreign Application Priority Data
Mar. 10, 2004 (JP) 2004-067577

(51) Int. Cl. H04N 9/04

(52) U.S. Cl. 348/272

(57) ABSTRACT

A multi-spectral image capturing apparatus having different spectral sensitivity characteristics of at least four bands comprises an imaging optical system, a camera section including single-panel color image capturing section, and a split optical system configured to split a light beam of an image from the imaging optical system into plural light beams, and form images again respectively on split image formation planes. The single-panel color image capturing section of the camera section has an image formation position on the split image formation planes.

### CROSS REFERENCE TO RELATED APPLICATIONS

This is a Continuation Application of PCT Application No. PCT/JP2005/004130, filed Mar. 9, 2005, which was published under PCT Article 21(2) in Japanese.

This application is based upon and claims the benefit of priority from prior Japanese Patent Application No. 2004-067577, filed Mar. 10, 2004, the entire contents of which are incorporated herein by reference.

### BACKGROUND OF THE INVENTION

1. Field of the Invention

The present invention relates to a multi-spectral image capturing apparatus having spectral sensitivity characteristics of four or more bands. The present invention further relates to an adapter lens used inserted at an intermediate portion between an imaging optical system and an image capturing system capable of capturing a color image, to configure such a multi-spectral image capturing apparatus as noted above.

2. Description of the Related Art

Image capturing apparatuses of four bands or more are disclosed in, for example, U.S. Pat. No. 5,864,364, Jpn. Pat. Appln. Publications No. 2002-296114, No. 2003-23643, and No. 2003-87806, etc. U.S. Pat. No. 5,864,364 discloses a device using a rotary filter in which plural optical band pass filters are arranged along the circumference, to achieve multi-band image capturing in time division fashion. On the other hand, Jpn. Pat. Appln. Publication No. 2002-296114 discloses a device which easily performs multi-band capturing of an image by use of a filter which divides a spectral wavelength band into multiple bands. Further, Jpn. Pat. Appln. Publications No. 2003-23643 and No. 2003-87806 disclose structures of a multi-spectral camera capable of capturing multiple bands simultaneously.

### BRIEF SUMMARY OF THE INVENTION

According to a first aspect of the present invention, there is provided a multi-spectral image capturing apparatus having different spectral sensitivity characteristics of at least four bands, comprising:

an imaging optical system;

a camera section including single-panel color image capturing section; and

a split optical system configured to split a light beam of an image from the imaging optical system into plural light beams, and form images again respectively on split image formation planes, wherein

the single-panel color image capturing section of the camera section has an image formation position on the split image formation planes.

According to a second aspect of the present invention, there is provided an adapter lens used inserted between an imaging optical system and a camera section capable of capturing a color image, comprising:

a split optical system configured to split a light beam of an image from the imaging optical system into plural light beams, and form images again respectively on split image formation planes; and

optical filters equipped for the split plural light beams, wherein
a characteristic of at least one of the optical filters is a comb-shaped characteristic which divides, at wavelength regions, spectral sensitivity characteristic of primary colors of an image capturing system comprised in the camera section and capable of capturing a color image.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing structure of a multi-spectral image capturing apparatus according to a first embodiment of the present invention;

FIG. 2 is a view showing an example of a split optical system used in the multi-spectral image capturing apparatus according to the first embodiment;

FIG. 3 is a graph showing spectral transmittance characteristics of one of two band-pass filters used in the multi-spectral image capturing apparatus according to the first embodiment;

FIG. 4 is a graph showing spectral transmittance characteristics of the other one of the two band-pass filters used in the multi-spectral image capturing apparatus according to the first embodiment;

FIG. 5 is a graph showing spectral sensitivity characteristics of a single-panel color image sensor used in the multi-spectral image capturing apparatus according to the first embodiment;

FIG. 6 is a view showing principles of image synthesis in the first embodiment;

FIG. 7 is a graph showing spectral sensitivity characteristics of respective bands, obtained by the multi-spectral image capturing apparatus according to the first embodiment;

FIG. 8 is a view showing structure of a camera system to which an adapter lens according to the first embodiment of the present invention can be applied;

FIG. 9 is graphs for describing principles of image capturing in case of using four-color image sensor in the first embodiment;

FIG. 10 is a view showing an example of a camera system capable of practicing a modification 1 of the first embodiment;

FIG. 11 is a view showing structure of a multi-spectral image capturing apparatus according to the modification 1 of the first embodiment;

FIG. 12 is a view showing structure of a multi-spectral image capturing apparatus according to a modification 2 of the first embodiment;

FIG. 13 is a view showing a display example of a liquid crystal screen according to the modification 2 of the first embodiment;

FIG. 14 is a view showing another display example of the liquid crystal screen according to the modification 2 of the first embodiment;

FIG. 15 is a view showing structure of a multi-spectral image capturing apparatus according to a second embodiment of the present invention;

FIG. 16 is a schematic view where a filter attachment part is observed from a position slightly close to the optical axis;

FIG. 17 is a view for describing principles of image synthesis according to the second embodiment;

FIG. 18 is a view showing structure of a multi-spectral image capturing apparatus according to a third embodiment of the present invention;

FIG. 19 is a schematic view where a filter attachment part is observed from a position slightly close to the optical axis;

FIG. 20 is a view for describing principles of resolution processing according to the third embodiment;

FIG. 21 is a diagram showing a structure example of an image processing section in the third embodiment;

FIG. 22 is a view showing structure of a multi-spectral image capturing apparatus according to a fourth embodiment of the present invention;

FIG. 23 is a schematic view where a filter attachment part is observed from a position slightly close to the optical axis;

FIG. 24 is a view showing a display example of a liquid crystal screen in a resolution priority mode in case where an image capturing mode is indicated in the form of letters;

FIG. 25 is a view showing a display example of the liquid crystal screen in the resolution priority mode in case where the image capturing mode is indicated in the form of a figure or a simplified symbol;

FIG. 26 is a view showing a pixel array of a color image sensor;

FIG. 27 is a view showing only G pixels extracted from the pixel array shown in FIG. 26;

FIG. 28 is a view showing positional relationship between pixels of a filter a and those of a filter d;

FIG. 29 is a view showing positional relationship between pixels of a filter b and those of the filter d;

FIG. 30 is a view showing positional relationship between pixels of a filter c and those of the filter d;

FIG. 31 is a view showing pitch of synthesized pixels;

FIG. 32 is a view showing a display example of the liquid crystal screen in a dynamic range priority mode in case where the image capturing mode is indicated in the form of letters;

FIG. 33 is a view showing a display example of the liquid crystal screen in a dynamic range priority mode in case where the image capturing mode is indicated in the form of a figure or a simplified symbol;

FIG. 34 is a view showing a display example of the liquid crystal screen in the color reproducibility priority mode in case where the image capturing mode is indicated in the form of letters;

FIG. 35 is a view showing a display example of the liquid crystal screen in the color reproducibility priority mode in case where the image capturing mode is indicated in the form of a figure or a simplified symbol; and

FIG. 36 is graphs for explaining principles of image capturing in the color reproducibility priority mode in the fourth embodiment.

### DETAILED DESCRIPTION OF THE INVENTION

Preferred embodiments of the present invention will be described below with reference to the accompanying drawings.

### First Embodiment

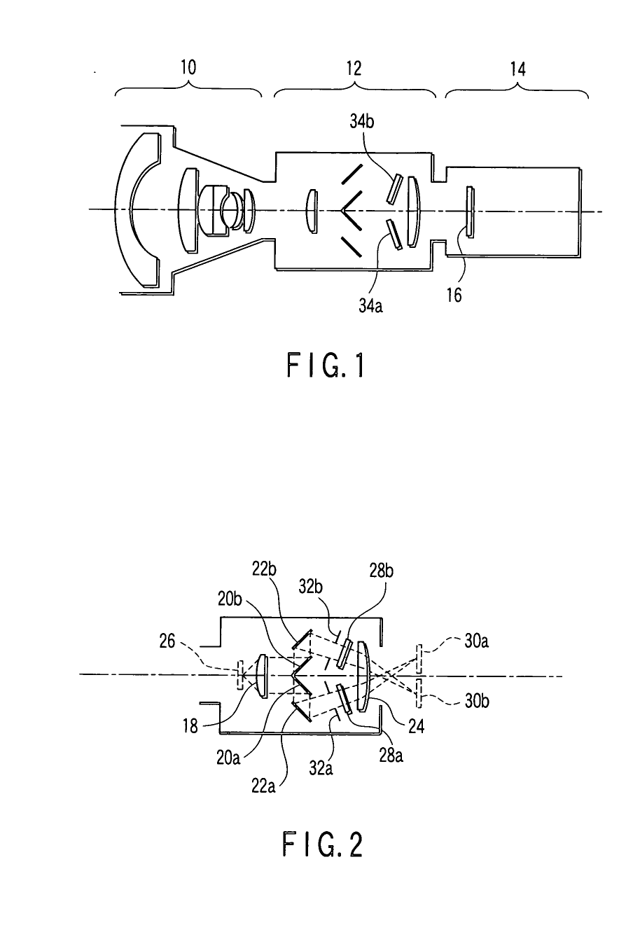

In FIG. 1, a multi-spectral image capturing apparatus according to a first embodiment of the present invention is configured by an imaging optical system 10, a split optical system 12, and a camera section 14, as shown in FIG. 1. The split optical system 12 splits a light beam of an image from the imaging optical system 10 into plural beams, and makes the split light beams form images respectively on their own split image formation planes, again. The camera section 14 includes a single-panel color image sensor 16 which have image formation positions on the split image formation planes. In the multi-spectral image capturing apparatus having a structure of this kind, light from a subject not shown forms a subject image on the single-panel color image sensor 16 of the camera section 14 through the imaging optical system 10 and split optical system 12.

FIG. 2 shows an example of the split optical system 12 noted above, and operation thereof will be described. That is, the split optical system 12 is configured by a collimator lens 18, mirrors 20a and 20b, and return mirrors 22a and 22b, and an image formation lens 24. If the subject image is formed on a primary image formation plane 26 by the imaging optical system 10 not shown in the figure, the image is transformed into parallel light by the collimator lens 18, and is split into two parallel beams by the mirrors 20a and 20b. These split light beams are respectively returned by the return mirrors 22a or 22b, and pass through the filter attachment parts 28a and 28b. The beams form images on split image formation planes 30a and 30b by the image formation lens 24. If nothing is provided at the filter attachment parts 28a and 28b, the same images are formed on the split image formation planes 30a and 30b. Masks 32a and 32b are used to prevent images through the split light paths from overlapping each other on the image formation planes of their own.

In the present embodiment, the single-panel color image sensor 16 shown in FIG. 1 is positioned on the split image formation planes 30a and 30b in FIG. 2.

Also as shown in FIG. 1, filters 34a and 34b are attached to the filter attachment parts 28a and 28b. Therefore, an image which has passed through the filter 34a is formed on the upper half of the single-panel color image sensor 16. Another image which has passed through the filter 34b is formed on the lower half thereof.

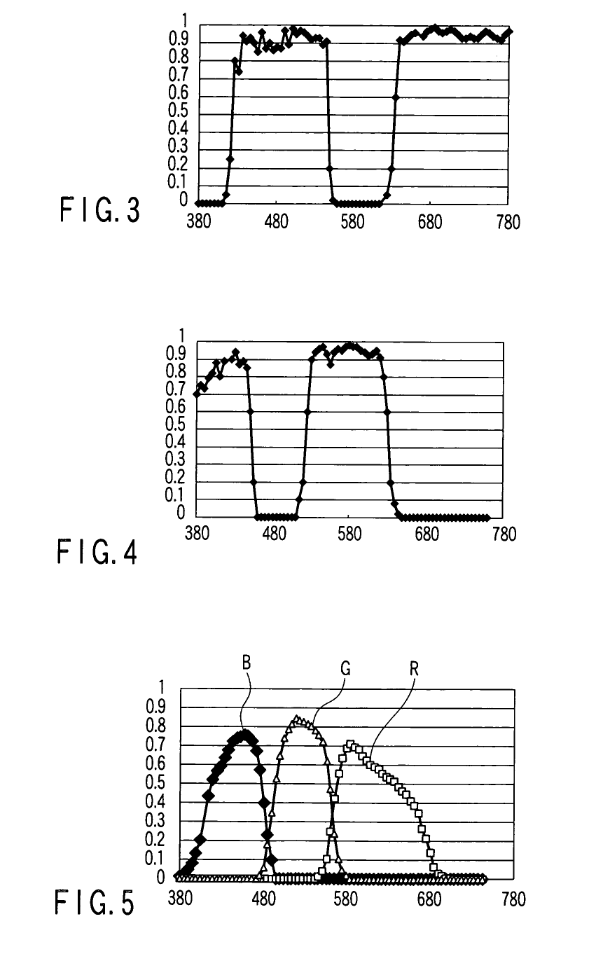

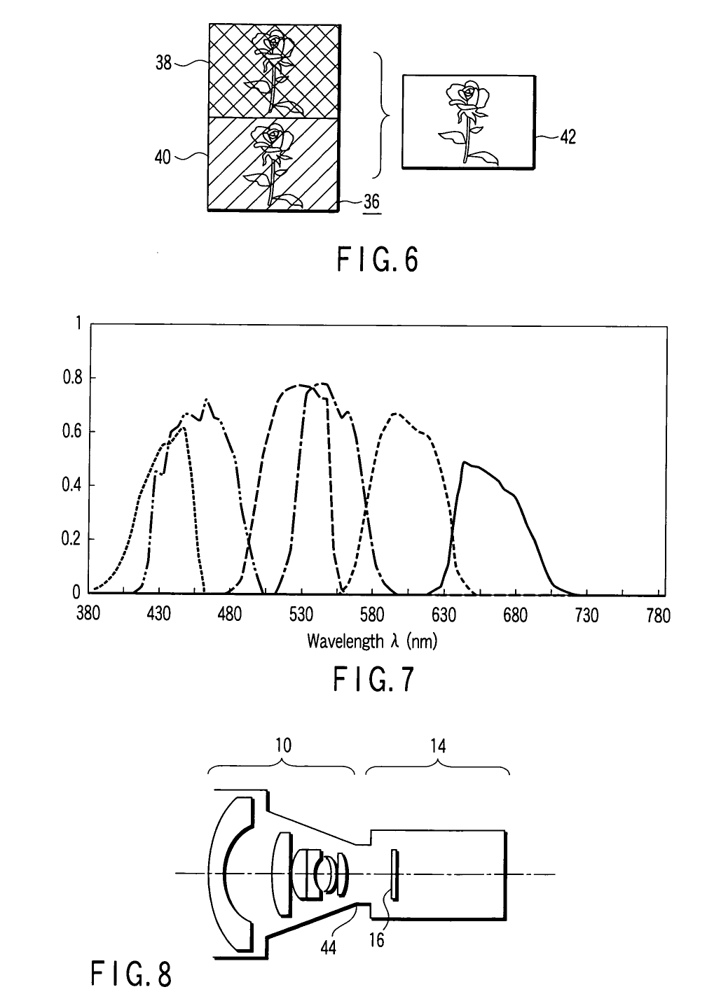

The filter 34a used at this time is a band-pass filter having a comb-shaped spectral transmittance as shown in FIG. 3. The other filter 34b is a band-pass filter having a comb-shaped spectral transmittance as shown in FIG. 4. The present embodiment uses as a color image sensor the single-panel color image sensor 16 in which RGB color filters are arranged in a Beyer array in each pixel. The RGB filters of this single-panel color image sensor 16 respectively have spectral shapes as shown in FIG. 5. In contrast, the band-pass filters as the filters 34a and 34b have comb-shaped spectral transmittances as noted above. The band-pass filters allow light of about half of each RGB wavelength band to pass. Therefore, an image signal read from the single-panel color image sensor 16 is split into upper and lower halves, which are synthesized with each other to realize 6-band color image capturing. That is, as shown in FIG. 6, an image 36 output from the single-panel color image sensor 16 is split into an upper half which is an image 38 on the split image formation plane 30a and a lower half which is an image 40 on the split image formation plane 30b. By synthesizing these images, a 6-band color image 42 can be obtained. In this case, the spectral sensitivity characteristics of the six bands are as shown in FIG. 7. This 6-band synthesis processing may be performed by a processor not shown but included in the camera section 14 or by software processing after transferring image data captured to a personal computer or the like.

The split optical system 12 equipped with the filters 34a and 34b as described above is configured as the adapter lens of the first embodiment of the present invention. As a general color camera system of a type shown in FIG. 8 in which the imaging optical system 10 and the camera section 14 are separable by a lens mount 44, for example, there are a single-lens reflex camera, a TV camera with interchangeable lenses, a digital camera, etc. Therefore, the adapter lens according to the present embodiment is connected between the imaging optical system 10 and the camera section 14 in this kind of camera system, thereby enabling 6-band image capturing.

Although the present embodiment does not use an infrared cut filter, image data covering a longer red wavelength can be obtained by this. This wavelength is an effective wavelength range for various observations. However, adoption of a measure of using an infrared cut filter or the like does not deviate from the idea of the present invention.

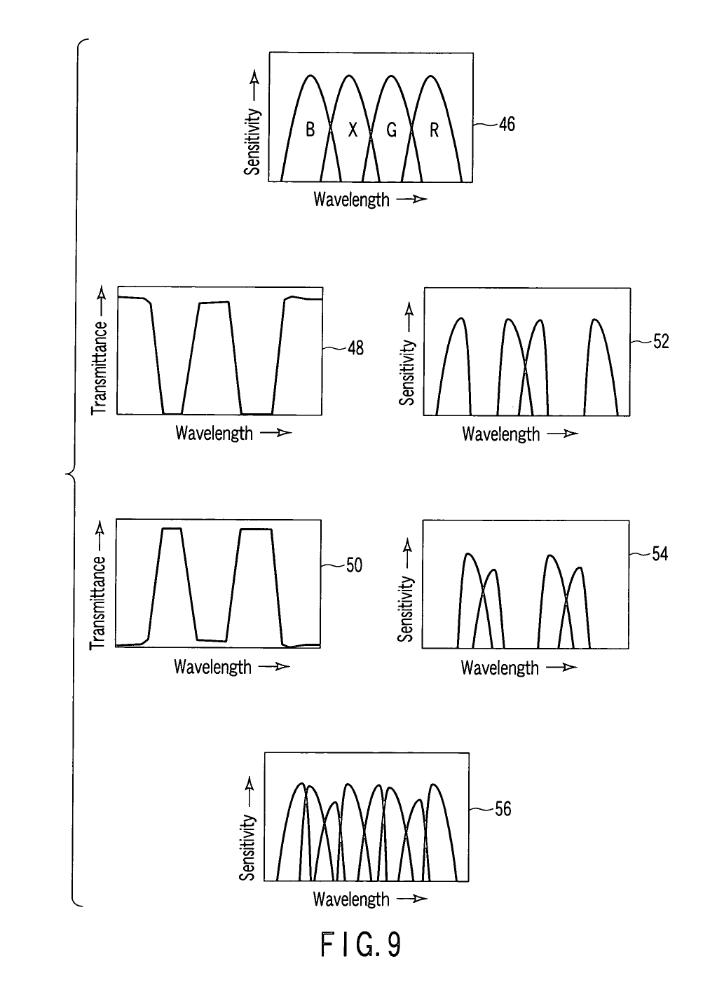

The present embodiment also cites a single-panel color image sensor having an RGB three-color filter array, as an example of the single-panel color image sensor 16, which is not limited to three colors. Another image sensor having a color filter array of four or more colors may be used. In case of a four-color filter array, principles of multi-band image capturing will be described with reference to FIG. 9. The reference numeral 46 denotes a spectral sensitivity characteristics of pixels corresponding to respective colors of the four-color filter array. The numeral 48 denotes a wavelength transmittance characteristic of the filter 34a in case of using a color image sensor having the spectral sensitivity characteristics noted above. The numeral 50 denotes a wavelength transmittance characteristic of the filter 34b. Therefore, products obtained by multiplying the spectral sensitivity characteristics 46 of pixels corresponding to the respective colors of the four-color filter array by the wavelength transmittance characteristic 48 of the filter 34a are the spectral sensitivity characteristics 52 of image data which passes through the filter 34a. Likewise, products obtained by multiplying the spectral sensitivity characteristics 46 of pixels corresponding to the respective colors of the four-color filter array by the wavelength transmittance characteristic 50 of the filter 34b are spectral sensitivity characteristics 54 of the image data which passes through the filter 34b. Therefore, 8-band spectral sensitivity characteristics 56 of the image data which passes through the filters 34a and 34b can be obtained. Thus, a multi-spectral image capturing apparatus that can obtain image data pieces each having four bands and also 8-band image data can be constructed.

The structure of the image sensor for colorization is not limited to a color filter array but may use a three-panel type or four-panel type color image capturing unit.

### Modification 1 of the First Embodiment

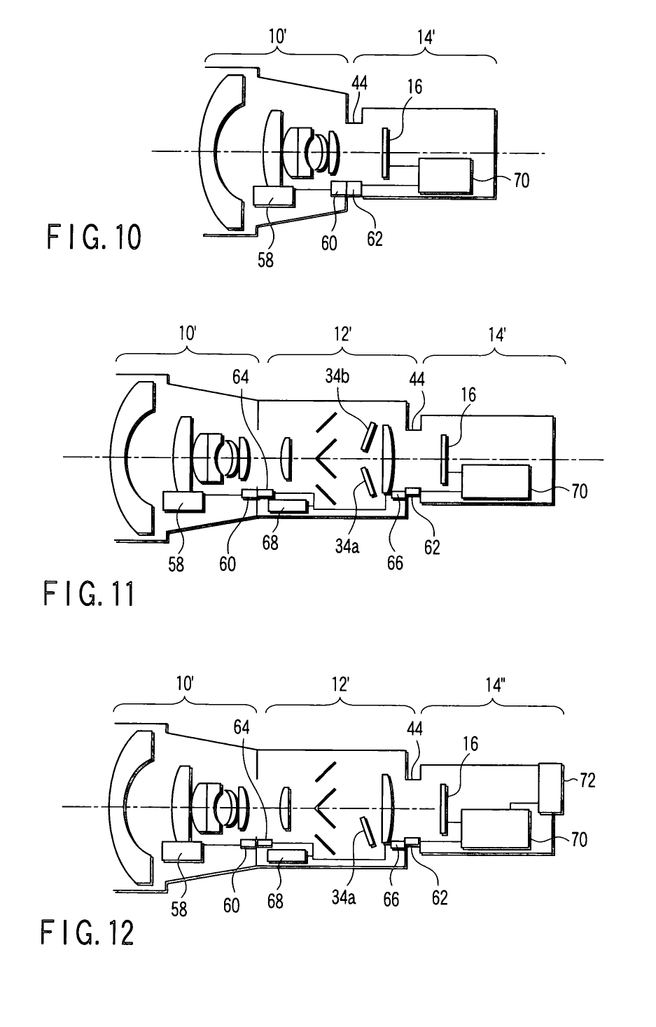

A kind of camera system having the lens mount 44 often has a lens control section 58 to control a diaphragm, a focus, and the like inside an imaging optical system 10′, and terminals (a lens-side terminal 60 and a camera-side terminal 62) to make communication between the side of a camera section 14′ and the lens control section 58, as shown in FIG. 10. In this kind of camera system, if the split optical system 12 as described above is attached as an adapter lens between the imaging optical system 10′ and the camera section 14′, the camera section 14′ determines that the lens is not attached. As a result, the system does not operate normally or operate at all in some cases.

Hence, as shown in FIG. 11, in order to correspond to such a camera system, a split optical system 12′ provided with similar terminals (a lens-side relay terminal 64 and a camera-side relay terminal 66) is used as the split optical system. In case of the split optical system 12′ having this structure, the camera-side terminal 62 and the lens-side terminal 60 can be electrically connected by attaching this system 12′ between the imaging optical system 10′ and the camera section 14′. Thus, the camera section 14′ can be operated normally.

An information storage section 68 electrically connectable to the camera-side relay terminal 66 may further be provided in the split optical system 12′. In this fashion, a processor 70 on the side of the camera section 14′ can be let recognize that the split optical system 12′ has been attached. Further, processing of a signal from the single-panel color image sensor 16 can be switched from processing for normal image capturing to other processing for multi-band image capturing. The information recorded in the information storage section 68 includes information concerning a model number of the split optical system 12′, types and characteristics of attached filters 34a and 34b, and spectral sensitivity characteristics, diaphragm and focus positions of the single-panel color image sensor 16 in the camera section 14′ connected. This information storage section 68 is configured by an electrical switch, a semiconductor memory, etc.

The camera section 14′ may have an external output terminal to output externally an image output processed by the processor 70, various information stored in the information storage section 68, and the like.

### Modification 2 of the First Embodiment

As shown in FIG. 12, no filter is inserted in one filter attachment part (for example, the filter attachment part 28b) split inside the split optical system 12′ while a filter (the filter 34a in this case) is attached only to the other filter attachment part (for example, the filter attachment part 28a). The filter 34a used here is a filter having characteristics as shown in FIG. 3. As a result, the identical six bands are constituted by narrow bands R1, G1, and B1 and wide bands R2, G2, and B2. Use efficiency of light improves so that SNR of a reproduced image improves.

A camera section 14″ has a liquid crystal screen 72 and can transform a signal from the single-panel color image sensor 16 into a displayable signal by the processor 70, and display the signal in real time. As a result of this, an image of a subject being currently captured by the single-panel color image sensor 16 can be checked, so that the focus, field angle, exposure, and the like can be adjusted.

That is, if the split optical system 12′ is not connected to the processor 70 of the camera section 14″, the processor 70 operates in a normal camera mode, and forms image data obtained from the single-panel color image sensor 16, entirely directly as an output image. The processor 70 further transforms the whole image data into a data format displayable on the liquid crystal screen 72, and outputs the data to the liquid crystal screen 72.

In contrast, if the split optical system 12′ is connected, the processor 70 can read information recorded on the information storage section 68 in the split optical system 12′ and recognize that no filter is attached to the filter attachment part 28b. Further, the processor 70 reads image data only from the split image formation positions corresponding to the single-panel color image sensor 16 (the split image formation plane 30b in this case), to form an output image. The processor 70 transforms the output image into a data format displayable on the liquid crystal screen 72, and outputs the image to the liquid crystal screen 72. As a result of this, positioning or the like can be performed in the same manner as in a normal camera mode.

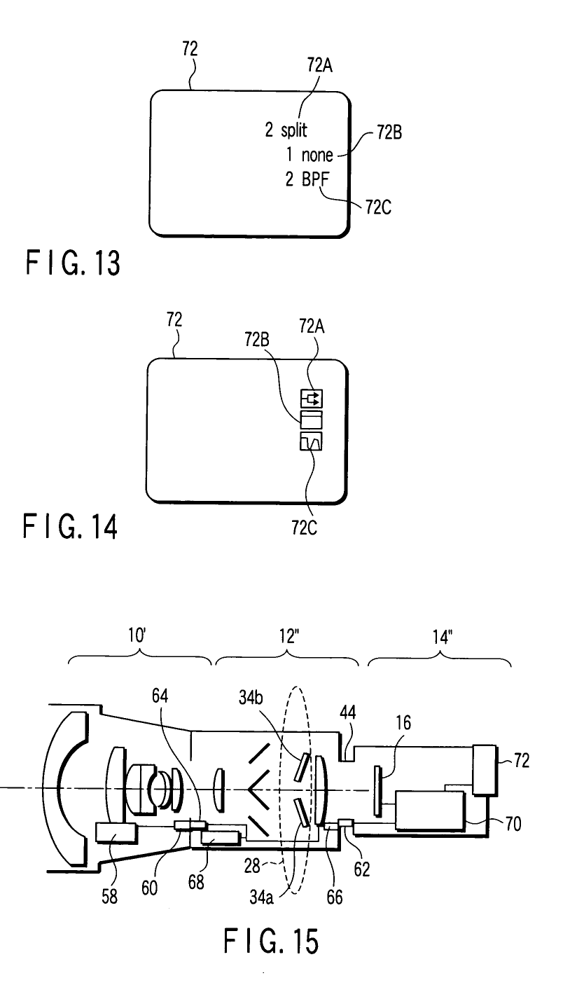

Also, on the liquid crystal screen 72, an indication is given informing that the split optical system 12′ is connected at present. This can be displayed by letters or by a figure which is easily understandable. FIGS. 13 and 14 show states of the displayed information. That is, FIG. 13 adopts indication using letters, “2 split” is displayed in a display part 72A indicating the type of split optical system being connected. FIG. 14 shows a case of displaying these by figures. These pieces of information are realized by displaying information superimposed on output image data corresponding to an image of a subject captured by the single-panel color image sensor 16.

Further, the type of the filter attached to the split optical system 12′ may be indicated on the liquid crystal screen 72. That is, in FIG. 13, “1 none” is indicated in a display part 72B indicating the type of the filter attached to the filter 1, and “2 BPF” is indicated in another display part 72C indicating the type of the filter attached to the filter 2. FIG. 14 shows a case of indicating these by figures.

Although an example in which no filter is inserted in the filter attachment part 28b has been cited above, a glass plate or the like to match the length of a light path to another split light path may be attached.

### Second Embodiment

Although the above first embodiment adopts 2-split, a 4-split optical system may be configured by the same structure. An example of using a 4-split optical system will now be described as a second embodiment of the present invention.

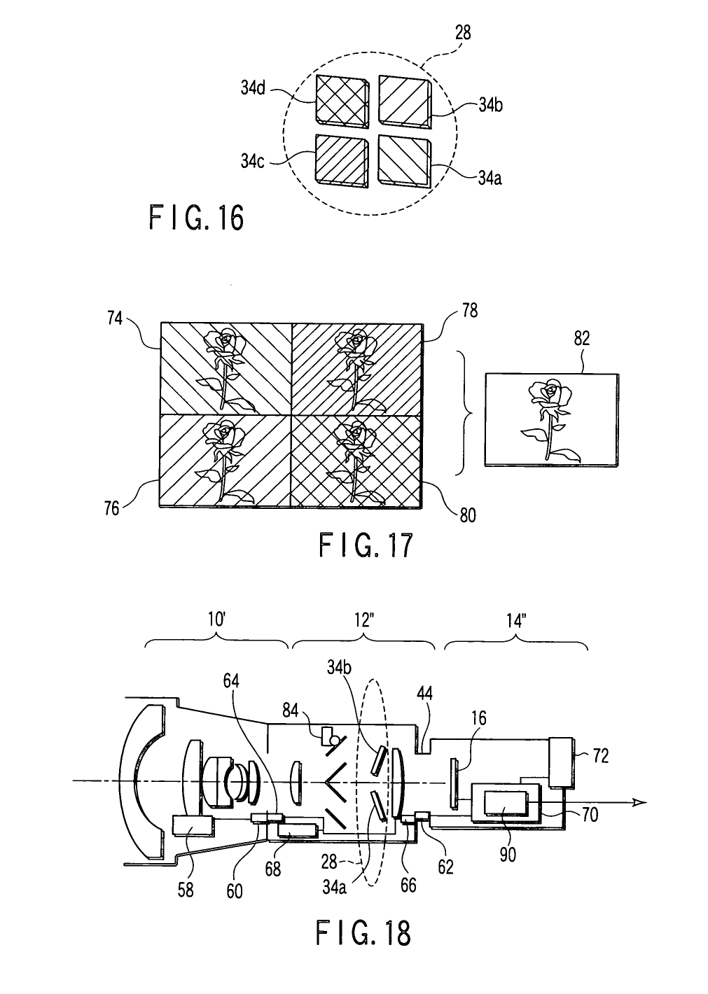

FIG. 15 is a view showing structure of a multi-spectral image capturing apparatus according to the present embodiment, using a 4-split optical system 12″. FIG. 16 is a schematic view where a filter attachment part 28 is observed from a position slightly close to the optical axis. The part of the filter attachment part 28 indicated as an ellipse of a broken line has a structure in which filters can be attached at positions respectively corresponding to four split light paths, as shown in FIG. 16. The split light paths are respectively denoted at a, b, c, and d, and corresponding filters are respectively referred to as filters 34a, 34b, 34c, and 34d. Corresponding image formation positions on a single-panel color image sensor 16 are respectively referred to as image formation planes a, b, c, and d.

The filters 34a and 34b use the same filters as used in FIG. 1. The filter 34c uses a transparent glass plate. The filter 34d uses an ND filter having a transmittance of 5%. A light beam which has passed through an imaging optical system 10′ is split by the split optical system 12″ into four beams, which respectively pass through the filters 34a, 34b, 34c, and 34d and imaged on the image formation planes a, b, c, and d.

The camera section 14″ has a liquid crystal screen 72, and can transform a signal from the single-panel color image sensor 16 into a displayable signal by the processor 70, and display the signal on real time. As a result of this, an image of a subject being currently captured by the single-panel color image sensor 16 can be checked, so that the focus, field angle, exposure, and the like can be adjusted. That is, if the split optical system 12″ is connected, the processor 70 of the camera section 14″ reads information recorded in the information storage section 68 of the split optical system 12″, and recognizes that the filter 34c is a transparent filter. The processor 70 further reads out image data of the image formation plane c as a split image formation position corresponding to the filter 34c of the single-panel color image sensor 16, and displays the image data on the liquid crystal screen 72. In this manner, positioning or the like can be carried out in the same manner as in a normal camera mode.

FIG. 17 is a view showing a state of images on respective image formation planes obtained from the single-panel color image sensor 16. Like in the above first embodiment, a multi-spectral image of six bands as shown in FIG. 7 can be obtained by combining an image 74 on the image formation plane a and an image 76 on the image formation plane b.

An image 78 which has passed through the filter 34c (e.g., a transparent glass plate) is obtained on the image formation plane c. Therefore, this image 78 can be dealt with as 9-band image data which combines the characteristics of the six bands with the other three bands shown in FIG. 5.

Further, light which has passed through an ND filter having a transmittance of 5% forms an image on the image formation plane d. Therefore, even if a very bright part which may cause halation on the image formation plane c may be included in the screen, an image 80 can be obtained without being whitened. This is synthesized so as to compensate for a whitened part in a reproduced image obtained by subjecting the nine bands noted above to synthesis processing. In this manner, even if a bright part exists in the screen, a color image 82 can be obtained without being whitened.

In this case, only the ND filter is used, a comb-shaped band pass filter as used for the filters 34a and 34b can be used in combination with the ND filter. For example, the filters 34a and 34b are configured to have the same structure. A comb-shaped filter used for the filter 34a and an ND filter are used together as the filter 34c. As the filter 34d, a comb-shaped band pass filter used for the filter 34b and an ND filter are used together. In this structure, images of the filters 34a and 34c are synthesized with one another, and images of the filters 34b and 34d are synthesized with one another. Thus, a 6-band multi-spectral image can be obtained without being whitened.

As a method of synthesizing an image through an ND filter and another image without an ND filter, a general synthesis method can be used, e.g., a method of synthesizing an image obtained through an ND filter into a halation part of another image obtained without an ND filter, or a method of multiplying signal values by a coefficient corresponding to the transmittance of the ND filter and by adding up them to achieve synthesis. The transmittance of the ND filter is not limited to 5% but the present embodiment may be constructed using an ND filter optimal for purposes of use.

Also, the present embodiment uses a transparent glass plate as a filter 34c. This means that the filter has no wavelength filtering characteristic. The same effect can be obtained if the structure is arranged such that nothing is inserted in this place.

### Modification of the Second Embodiment

A modification of the second embodiment will now be described below referring continuously to FIGS. 15 and 16.

In this modification, each of filters 34a to 34d attached to the filter attachment part 28 can be replaced by the user in accordance with subjects to be captured or purposes of use. Information of a replaced filter can be recorded as a mode of the filter in the information storage section 68 by the user. The processor 70 of the camera section 14″ executes color reproduction processing on the basis of this mode information. As a result of this, more accurate color reproduction processing can be carried out for every purpose.

In FIG. 15, the information storage section 68 is formed in the split optical system 12″. However, the information storage section 68 may be configured to be included in the camera section 14″ or the imaging optical system 10′.

### Third Embodiment

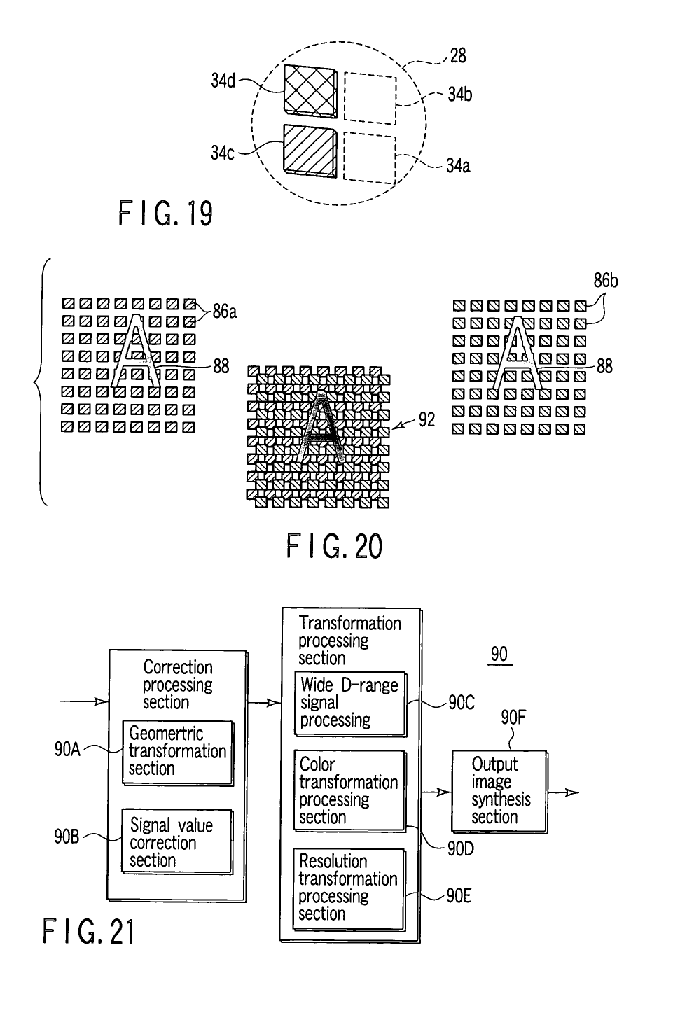

FIG. 18 is a view showing a multi-spectral image capturing apparatus according to a third embodiment of the present invention, using a 4-split optical system 12″′. The part of the filter attachment part 28 indicated by an ellipse of a broken line in this figure has a structure in which filters can be attached at positions respectively corresponding to four split light paths, as shown in FIG. 19, like in FIGS. 15 and 16. The split light paths are respectively denoted at a, b, c, and d, and corresponding filters are respectively referred to as filters 34a, 34b, 34c, and 34d. Corresponding image formation positions on a single-panel color image sensor 16 are respectively referred to as image formation planes a, b, c, and d. In the present embodiment, nothing is attached as the filter 34a or 34b. A comb-shaped band-pass filter having characteristics as shown in FIG. 3 is used for the filter 34c, and an ND filter having a transmittance of 5% is used for the filter 34d

A 4-split optical system 12″′ used in the present embodiment has a mirror adjustment section 84 capable of fixing a mirror at a angle adjusted finely. As this mirror adjustment section 84, the present embodiment includes a mirror adjustment section 84 capable of finely adjusting the angle of a light beam passing through the filter 34b. This enables fine adjustment of the position of an image on an image formation plane b, which has passed through the filter 34b. Using this mirror adjustment section 84, the mirror angle is finely adjusted in advance such that the positions of images of a subject and the relative positions of pixels of the single-panel color image sensor 16 are shifted vertically and horizontally by a half pixel pitch, relatively to an image which has passed through the filter 34b.

FIG. 20 shows interrelationship between the pixel positions of each image formation plane and the position of a subject image. In this figure, the reference numeral 86a designates pixel positions of the image formation plane a, and the reference numeral 86b denotes the pixel positions of the image formation plane b. A subject image 88 on the image formation plane b is shifted upward by a half pixel pitch and leftward also by a half pixel pitch from another subject image 88 on the image formation plane a.

An image processing section 90 formed in the processor 70 of the camera section 14″ is configured by a geometric transformation section 90A, signal value correction section 90B, wide D-range signal processing section 90C, color transformation processing section 90D, resolution transformation processing section 90E, and output image synthesis section 90F, as shown in FIG. 21. If necessary, presetting may be available so as to combine these processing to obtain desired output image data.

That is, image data from the single-panel color image sensor 16 is to correct deformation and shading of a subject caused by the imaging optical system 10′ and the split optical system 12″′, for every image formation plane, via the geometric transformation section 90A and signal value correction section 90B of the image processing section 90. As a result of this, data of a subject image free from deformation and shading can be obtained. From image data which has passed through the filters 34b and 34c, 6-band multi-spectral image data can be obtained. This is subjected to a color transformation processing by a predetermined algorithm by the color transformation processing section 90D of the image processing section 90. As a result, accurate color information of the subject can be obtained. Further, image data which has passed through the filter 34d and 6-band image data noted above are processed in combination with one another. In this manner, image data without being whitened can be obtained. Image data which has passed through the filter 34a and other image data which has passed through the filter 34b are shifted from one another by a half pixel pitch, as shown in FIG. 20. Hence, these image data pieces are synthesized by the resolution transformation section 90E of the image processing section 90, thereby to transform these image data pieces into image data 92 having a high resolution. In this fashion, image data can be obtained with a high resolution and accurate color reproduction without being whitened.

Information used when performing color transformation, such as spectral characteristic data reproduction illumination light data of the split optical system 12″′, color matching function data, characteristic data of a subject, and the like, may be stored in advance in the information storage section 68. If needed, the information may be read from the information storage section 68 and used for calculations.

In the present embodiment, the image processing section 90 is mounted in the camera section 14″. The present embodiment may be constructed as a system in which an image signal output from an external output terminal not shown of the camera section 14″ is input to an electronic processor such as a personal computer or the like. These processing is carried out by a program on the electronic processor.

### Fourth Embodiment

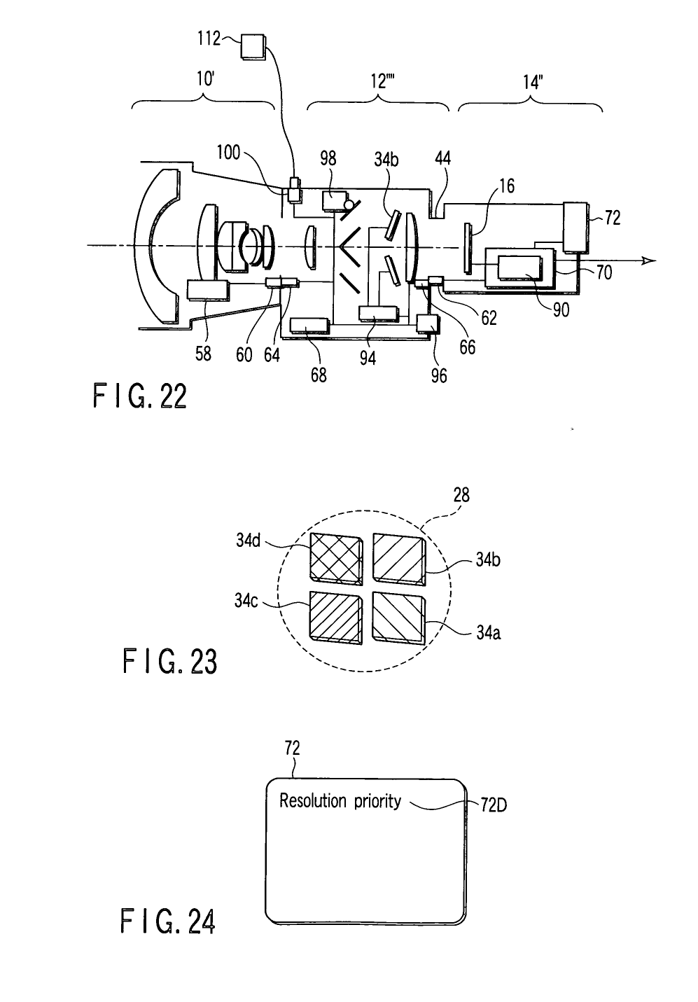

FIG. 22 is a view showing structure of a multi-spectral image capturing apparatus according to a fourth embodiment of the present invention, using a 4-split optical system 12″″. In this case, as shown in FIGS. 15 and 16, the filter attachment part 28 has a structure in which filters can be inserted at positions respectively corresponding to four split light paths as shown in FIG. 23. The split light paths are respectively denoted at a, b, c, and d, and corresponding filters are respectively referred to as filters 34a, 34b, 34c, and 34d. Corresponding image formation positions on a single-panel color image sensor 16 are respectively referred to as image formation planes a, b, c, and d.

In the present embodiment, wavelength tunable filters each capable of switching plural different transmittance wavelength characteristics by an electric signal are attached as the filters 34a to 34d. These wavelength tunable filters each can be switched to have characteristics as shown in FIG. 3 or 4 or characteristics of an ND filter having a transmittance of 5%. These four tunable filters are connected to a filter control section 94, and the filter control section 94 is connected to the processor 70 of the camera section 14″ through a camera-side relay terminal 66 of the split optical system 12″″ and a camera-side terminal 62 of the camera section 14″.

Further, the present embodiment is provided with a mode selection section 96 which allows users to select and set settings of filter characteristics and a processing mode of the processor 70. This mode selection section 96 is also connected to the processor 70 of the camera section 14″ through the camera-side relay terminal 66 of the split optical system 12″″ and the camera-side terminal 62 of the camera section 14″.

Furthermore, return mirrors of the split optical system 12″″ each are provided with a mirror drive control section 98 capable of finely adjusting the angle of a return mirror by an electric signal. This mirror drive control section 98 is also connected to the processor 70 of the camera section 14″ through the camera-side relay terminal 66 of the split optical system 12″″ and the camera-side terminal 62 of the camera section 14″. Please note that, for conveniences of the drawings, FIG. 22 shows only one mirror drive control section 98. However, four mirror drive control sections 98 are provided respectively corresponding to filters 34a to 34d. These sections are respectively referred to as mirror drive control sections a, b, c, and d.

Furthermore, the split optical system 12″″ is provided with an external sensor terminal 100 to which an external sensor can be connected. This external sensor terminal 100 is also connected to the processor 70 of the camera section 14″ through the camera-side relay terminal 66 of the split optical system 12″″ and the camera-side terminal 62 of the camera section 14″.

Also, the liquid crystal screen 72 is a high color gamut liquid crystal screen using an LCD panel of a frame sequential scheme having light sources as four color LEDs. This high color gamut liquid crystal screen has a broader color reproduction range than a screen of three primary colors and is capable of displaying vivid colors which cannot be displayed accurately by a three-primary color display.

The multi-spectral image capturing apparatus according to the present embodiment having a structure as described above operates differently depending on operation modes set by the user. The operation modes are three, i.e., a resolution priority mode, dynamic range priority mode, and color reproducibility priority mode. The user can select any of these modes by operating the mode selection section 96. Hereinafter, operation will be described for every mode.

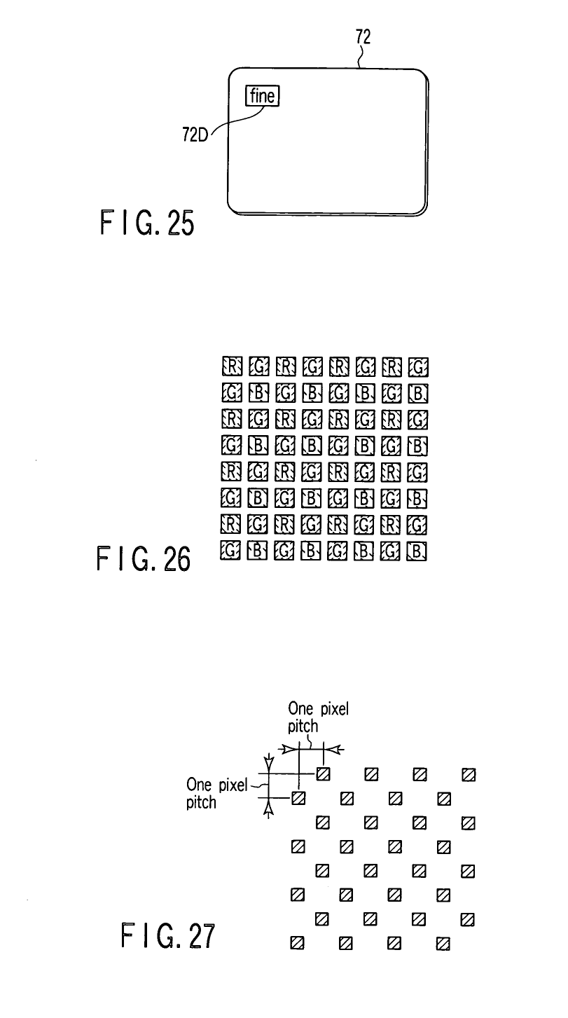

The resolution priority mode will be described first. If the processor 70 of the camera section 14″ recognizes the resolution priority mode has been selected by the mode selection section 96, the processor 70 lets the liquid crystal screen 72 display an indication of the “resolution priority mode” having been selected. This may be indicated in the form of letters or by an easily understandable figure. For example, FIG. 24 shows a case of indicating the image capturing mode by letters, letters of “resolution priority mode” is shown in a display part 72D for the image capturing mode. FIG. 25 shows an example in case of indicating the image capturing mode by a figure or by a simplified symbol.

In the resolution priority mode, the processor 70 sends a control signal to the filter control section 94, and sets the filter 34a (wavelength tunable filter a), filter 34b (wavelength tunable filter b), filter 34c (wavelength tunable filter c), and filter 34d (wavelength tunable filter d) each to the maximum transmittance of an ND filter.

Next, the processor 70 sends a control signal to the mirror drive control sections 98 (mirror drive control sections a, b and c) to adjust the angles of return mirrors. That is, the mirror drive control section a is let control the angle of the return mirror 22a so as to form an image at a position shifted rightward by a half pixel pitch and upward by a half pixel pitch, from the positional relationship between a subject image which has passed through the filter 34d and pixels. The mirror drive control section b is let control the angle of the return mirror 22b so as to form an image at a position shifted leftward by a half pixel pitch and upward by a half pixel pitch, from the positional relationship between the subject image which has passed through the filter 34d and pixels. The mirror drive control section c is let control the angle of the return mirror c (not shown) so as to form an image at a position shifted upward by one pixel pitch from the positional relationship between the subject image which has passed through the filter 34d and pixels.

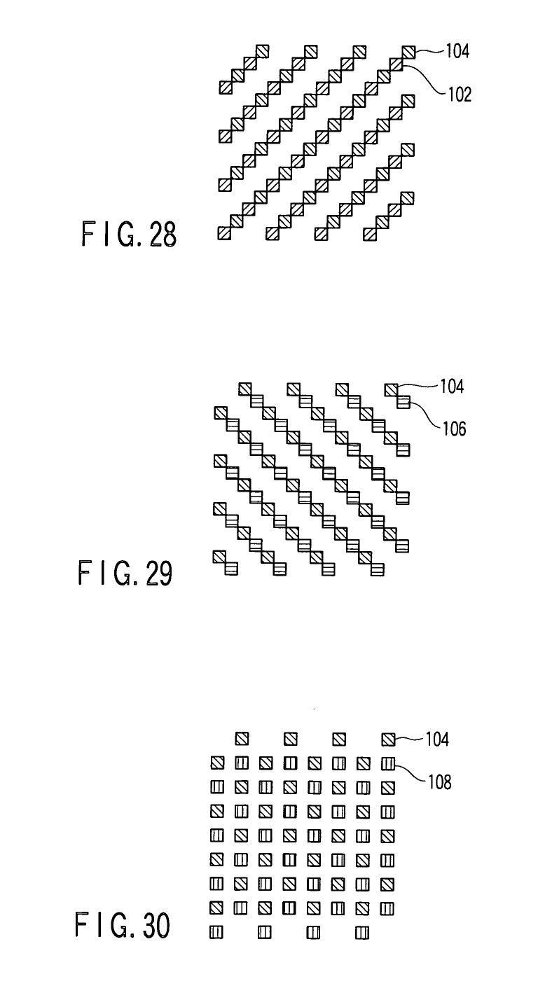

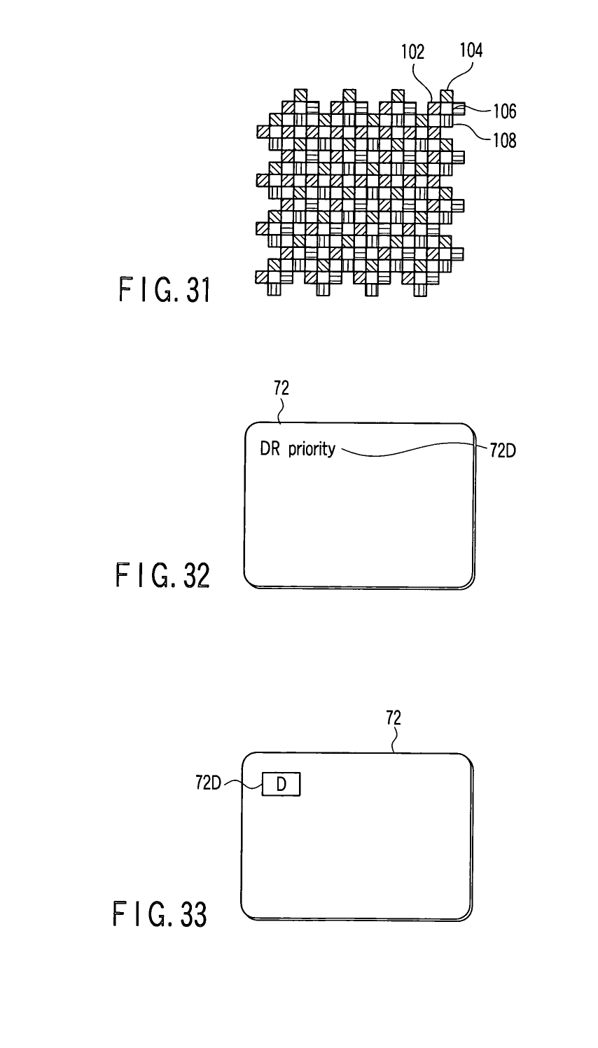

This state will now be described with reference to FIGS. 26 to 31. An array of a RGB color filter array is shown in FIG. 26. Of this array, G pixels contributes greatly to the resolution. Therefore, attention is paid to the G pixels. FIG. 27 shows a layout where only the G pixels are extracted. Mirrors have been adjusted as described above relatively to the positional relationship between the subject image and the pixels. Therefore, to align positions of subject images with each other, the pixel positions may be moved and synthesized in directions opposite to the directions of shifting as described above. As for the positional relationship between the pixels of the filter 34a and those of the filter 34d, the pixel 102 of the filter 34a moves downward to the left by a half pixel pitch from the pixel 104 of the filter 34d, as shown in FIG. 28, because the subject has been shifted upward to the right by a half pixel pitch. Similarly, as shown in FIG. 29, the pixel 106 of the filter 34b moves downward to the right by a half pixel pitch from the pixel 104 of the filter 34d. Further, as shown in FIG. 30, the pixel 108 of the filter 34c moves downward by one pixel pitch from the pixel 104 of the filter 34d. By thus moving and synthesizing pixels each, the resolution having a pixel pitch as shown in FIG. 31 can be obtained.

When this resolution priority mode is switched to another mode, the processor 70 sends a control signal to the mirror drive control sections 98 so as to return the return mirrors to original positions.

Thus, in case of the resolution priority mode, the resolution can be greatly improved.

Next, operation in the dynamic range priority mode will be described. If the processor 70 of the camera section 14″ recognizes that the dynamic range priority mode has been selected by the mode selection section 96, the processor 70 lets the liquid crystal screen 72 display an indication of the “dynamic range priority mode” having been selected. This may be indicated in the form of letters or an easily understandable figure. FIG. 32 shows a case of indicating the image capturing mode by letters, letters of “DR priority” is shown in the display part 72D for the image capturing mode. FIG. 33 shows an example in case of indicating the image capturing mode by a figure or a simplified symbol.

In the dynamic range priority mode, at first, the processor 70 sends a control signal to the filter control section 94, and sets the filter 34a (wavelength tunable filter a) to an ND filter having a transmittance of 100% (the maximum transmittance), the filter 34b (wavelength tunable filter b) to an ND filter having a transmittance of 10%, the filter 34c (wavelength tunable filter c) to an ND filter having a transmittance of 1%, as well as the filter 34d (wavelength tunable filter d) to an ND filter having a transmittance of 0.1%. Then, the image processing section 90 in the processor 70 multiplies image data which has passed through the filter 34b by a coefficient to make the signal value 10 times greater, multiplies image data which has passed through the filter 34c by another coefficient to make the signal value 100 times greater, as well as multiplies image data which has passed through the filter 34d by yet another coefficient to make the signal value 1000 times greater. Further, the resultants are synthesized with one another. In this manner, the dynamic range can be improved greatly.

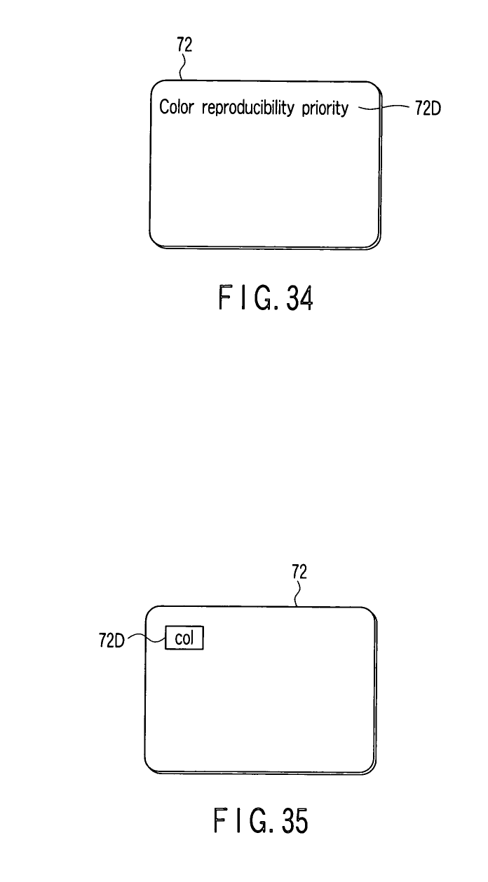

Next, operation in the color reproducibility priority mode will be described. If the processor 70 of the camera section 14″ recognizes that the color reproducibility priority mode has been selected by the mode selection section 96, the processor 70 lets the liquid crystal screen 72 display an indication of the “color reproducibility priority mode” having been selected. This may be indicated in the form of letters or an easily understandable figure. FIG. 34 shows a case of indicating the image capturing mode by letters, letters of “color reproducibility priority” is shown in the display part 72D for the image capturing mode. FIG. 35 shows an example in case of indicating the image capturing mode by a figure or a simplified symbol.

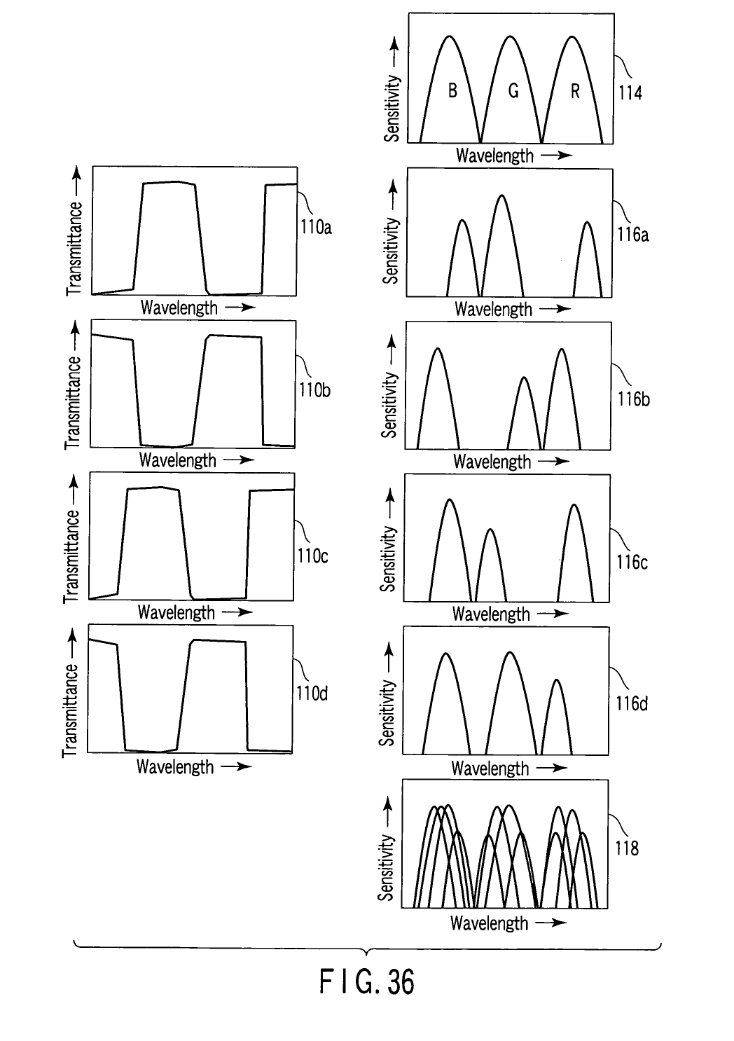

In the resolution priority mode, at first, the processor 70 sends a control signal to the filter control section 94, and sets the wavelength transmittance characteristics of each of the filter 34a (wavelength tunable filter a), the filter 34b (wavelength tunable filter b), the filter 34c (wavelength tunable filter c), and the filter 34d (wavelength tunable filter d). That is, the wavelength tunable filters are set to have the wavelength transmittance characteristic 110a of the filter 34a, the wavelength transmittance characteristic 110b of the filter 34b, the wavelength transmittance characteristic 110c of the filter 34c, and the wavelength transmittance characteristic 110d of the filter 34d, as shown in FIG. 36.

An illumination detection sensor 112 is electrically connected to the external sensor terminal 100. The illumination detection sensor 112 is a sensor capable of detecting illuminance, color temperature, spectra, and the like of illumination light.

The image processing section 90 in the processor 70 includes a color transformation processing section 90D as shown in FIG. 21. Although not specially shown in the figures, the color transformation processing section 90D has an illumination data storage section to store data from the illumination detection sensor 112. Also, the color transformation processing section 90D has a display device characteristic storage section (not shown) which stores plural device profiles for the display system. Stored in this storage section are a profile of an external monitor to display a color reproduction image, a profile of a high color gamut liquid crystal screen as the liquid crystal screen 72 mounted on the camera section 14″, etc.

In this color reproducibility priority mode, individuals of the filters 34a to 34d are set to have wavelength transmittance characteristics as described above. Therefore, the original sensitivity characteristics 114 of the single-panel color image sensor 16 as shown in FIG. 36 are influenced by characteristics of the filters. The spectral sensitivities of image data which has passed through the filters 34a to 34d, corresponding to respective bands, are then respectively as denoted at reference numerals 116a to 116d in this figure. With these characteristics, images are captured simultaneously. Thus, a multi-spectral image capturing apparatus of 12 bands which has spectral sensitivities shown at the reference numeral 118 in FIGS. 36 can be constructed.

Color transformation processing is carried out in the color transformation processing section 90D, based on these pieces of data of 12 bands, data of illumination light at time of capturing an image which has been stored in the illumination data storage section not shown but included in the color transformation processing section 90D, and a profile of the wide color gamut liquid crystal screen stored in the display device characteristic storage section not shown but included in the color transformation processing section 90D as well. The result is displayed on the liquid crystal screen 72 as a high color gamut liquid crystal screen and actual colors can be displayed accurately on the liquid crystal screen 72.

As for the color transformation processing, an accurate color reproduction image can be obtained by using a method as disclosed in U.S. Pat. No. 5,864,364. For transformation processing to be performed on a signal to be outputted to a four-primary-color high color gamut liquid crystal screen, a method described in Jpn. Pat. Appln. Publication No. 2000-253263 can be used.

Although the external sensor terminal 100 is included in the split optical system 12″″ in FIG. 22, this terminal may be provided in the camera section 14″ or the imaging optical system 10′. If the illumination detection sensor 112 is not connected, color reproduction processing can be carried out by dealing with illumination conditions preset in the color transformation processing section 90D in the same manner as information from the illumination detection sensor 112 is dealt with. In color transformation processing to display an image on an external monitor, the color transformation processing is carried out with a profile of a corresponding monitor selected among profiles of external monitors stored in the display device characteristic storage section not shown but included in the color transformation processing section 90D. As a result, a more accurate color reproduction image can be displayed. In this case, a four-primary-color LED is used so that colors covering a wider range within a color gamut can be displayed. In case where the colors of a subject to be captured distributes within a relatively narrow range in the color gamut, accurate colors can be reproduced even with a three-primary-color liquid crystal screen.

Operations in the three modes have been described above. However, the operation modes are not limited to the three described above but may be arranged so as to prioritize both the resolution and the dynamic range, or to perform processing in a complex manner by setting weight coefficients respectively for the resolution, the dynamic range and the color reproducibility.

The present invention has been described above on the basis of embodiments. However, the present invention is not limited to the above embodiments but various modification and applications are, of course, possible within the scope of the subject matter of the present invention.

For example, the split optical systems 12, 20′, 20″, 20″′, and 20″″ have been described as being attachable to and detachable from between the imaging optical systems 10 and 10′ and the camera sections 14, 30′, and 30″. However, the split optical system 12, 20′, 20″, 20″′, or 20″″ and the imaging optical system 10 or 10′ may be constructed in an integrated structure, which may be attachable to and detachable from the camera section 14, 30′, or 30″. Alternatively, the split optical system 12, 20′, 20″, 20″′, or 20″″ and the camera section 14, 30′, or 30″ may be constructed in an integrated structure, which may be attachable to and detachable from the imaging optical system 10 or 10′. Alternatively, the split optical system 12, 20′, 20″, 20″′, or 20″″, the imaging optical system 10 or 10′, and the camera section 14, 30′, or 30″ may be constructed in an integrated structure.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A multi-spectral image capturing apparatus having different spectral sensitivity characteristics of at least four bands, comprising:
an imaging optical system;
a camera section including single-panel color image capturing section; and
a split optical system configured to split a light beam of an image from the imaging optical system into plural light beams, and form images again respectively on split image formation planes, wherein
the single-panel color image capturing section of the camera section has an image formation position on the split image formation planes.

2. The multi-spectral image capturing apparatus according to claim 1, wherein the split optical system is equipped with optical filters for the split plural light beams.

3. The multi-spectral image capturing apparatus according to claim 1, wherein the color image capturing section has a single-panel color image sensor.

4. The multi-spectral image capturing apparatus according to claim 1, wherein the color image capturing section has an image capturing section which combines plural monochrome image sensors with an optical filter.

5. The multi-spectral image capturing apparatus according to claim 1, wherein
the imaging optical system includes a lens mount section configured to attach the imaging optical system to the camera section,
the camera section includes a first mount fixing section to which the imaging optical system can be directly attached,
the split optical system includes a split optical system mount section having the same shape as the lens mount section, and a second mount fixing section having the same shape as the first mount fixing section, and
the split optical system can be used with the lens mount section of the imaging optical system attached to the second mount fixing section of the split optical system, as well as the splitter optical mount section of the split optical system attached to the first mount fixing section of the camera section.

6. The multi-spectral image capturing apparatus according to claim 5, wherein
the lens mount section of the imaging optical system has a first communication terminal configured to communicate information concerning the imaging optical system to the camera section,
the first mount fixing section of the camera section has a second communication terminal electrically connected to a communication terminal,
the second mount fixing section and the split optical system mount section respectively have a first communication relay terminal and a second communication relay terminal corresponding to the first communication terminal and the second communication terminal, and
when the lens mount section of the imaging optical system is attached to the second mount fixing section of the split optical system and the split optical system mount section of the split optical system is attached to the first mount fixing section of the camera section, information concerning the imaging optical system and a control signal can be communicated between the imaging optical system and the camera section.

7. The multi-spectral image capturing apparatus according to claim 2, wherein an optical band-pass filter having a comb-shaped wavelength transmittance characteristic is used as the optical filter.

8. The multi-spectral image capturing apparatus according to claim 2, wherein an ND filter is used as the optical filter.

9. The multi-spectral image capturing apparatus according to claim 2, wherein a wavelength tunable filter having an electrically controllable transmittance wavelength characteristic is used as the optical filter.

10. The multi-spectral image capturing apparatus according to claim 2, wherein at least one of an optical band-pass filter having a comb-shaped wavelength transmittance characteristic, an ND filter, and a wavelength tunable filter having an electrically controllable transmittance wavelength characteristic is used as the optical filters.

11. The multi-spectral image capturing apparatus according to claim 2, wherein the optical filters are replaceable by a user.

12. The multi-spectral image capturing apparatus according to claim 10, further comprising an information storage section configured to store information of the optical filters.

13. The multi-spectral image capturing apparatus according to claim 12, wherein the information storage section further stores information concerning a spectral sensitivity characteristic of the color image capturing section, and diaphragms and focus positions of the imaging optical system and the split optical system.

14. The multi-spectral image capturing apparatus according to claim 1, wherein
the split optical system has mirrors configured to reflect the split light beams, and reflection angle adjustment sections configured to adjust angles of the mirrors, and
angles of the mirrors are adjusted by the reflection angle adjustment sections to make the positions of images on the image formation planes adjustable.

15. The multi-spectral image capturing apparatus according to claim 14, wherein the reflection angle adjustment sections are controllable by an electric signal.

16. The multi-spectral image capturing apparatus according to claim 15, wherein
the split optical system is equipped with optical filters for the split plural light beams, and
the multi-spectral image capturing apparatus further comprises an information storage section configured to store information of the plural optical filters and stores states of the reflection angle adjustment sections.

17. The multi-spectral image capturing apparatus according to claim 2, wherein the split optical system includes a terminal to which a sensor configured to detect an illumination condition at time of capturing an image can be connected.

18. The multi-spectral image capturing apparatus according to claim 3, wherein the color image capturing section has an image processing section configured to perform calculation processing on a signal value from the image sensor.

19. The multi-spectral image capturing apparatus according to claim 18, wherein the image processing section is configured to subject inputted image data to at least one of geographic transformation processing, shading correction processing, wide dynamic range signal processing, color transformation processing, and resolution transformation processing, and output the image data as output image data.

20. The multi-spectral image capturing apparatus according to claim 19, wherein
the split optical system has an image capturing mode setting section which a user can operate, and
based on an image capturing mode set in the image capturing mode setting section, the image processing section performs at least one of wide dynamic range signal processing, color transformation processing, and resolution transformation processing, and output a result thereof as the output image data.

21. The multi-spectral image capturing apparatus according to claim 4, wherein the color image capturing section has an image processing section configured to perform calculation processing on a signal value from the image sensor.

22. The multi-spectral image capturing apparatus according to claim 21, wherein the image processing section is configured to subject inputted image data to at least one of geographic transformation processing, shading correction processing, wide dynamic range signal processing, color transformation processing, and resolution transformation processing, and output the image data as output image data.

23. The multi-spectral image capturing apparatus according to claim 20, wherein
the split optical system has an image capturing mode setting section which a user can operate, and
based on an image capturing mode set in the image capturing mode setting section, the image processing section performs at least one of wide dynamic range signal processing, color transformation processing, and resolution transformation processing, and output a result thereof as the output image data.

24. The multi-spectral image capturing apparatus according to claim 2, wherein the camera section mounts a color liquid crystal monitor as a finder.

25. The multi-spectral image capturing apparatus according to claim 24, wherein the color liquid crystal monitor is a frame sequential type liquid crystal monitor using LEDs of three primary colors as a light source.

26. The multi-spectral image capturing apparatus according to claim 24, wherein the color liquid crystal monitor is a frame sequential type liquid crystal monitor using LEDs of at least four colors as a light source.

27. The multi-spectral image capturing apparatus according to claim 24, wherein the color liquid crystal monitor is a liquid crystal monitor using LEDs of at least four colors as a light source.

28. The multi-spectral image capturing apparatus according to claim 16, wherein the split optical system mounts a processor capable of individually controlling characteristics of the plural optical filters and the reflection angle adjustment sections.

29. The multi-spectral image capturing apparatus according to claim 24, further comprising an information storage section configured to store information of the optical filters, wherein
the camera section is configured to form an output image on the basis of image data which has passed through a predetermined one of the optical filters, as an image to be displayed on a color liquid crystal monitor as the finder on the basis of information in the information storage section and display the output image on the color liquid crystal monitor.

30. The multi-spectral image capturing apparatus according to claim 24, wherein whether the split optical system is connected or not and a type of the split optical system are displayed on the color liquid crystal monitor.

31. The multi-spectral image capturing apparatus according to claim 24, wherein information of filters used at time of capturing an image is displayed on the color liquid crystal monitor.

32. The multi-spectral image capturing apparatus according to claim 24, wherein
the split optical system has an image capturing mode setting section which can be operated by a user, and
a mode set by the image capturing mode setting section is displayed on the color liquid crystal monitor.

33. An adapter lens used inserted between an imaging optical system and a camera section capable of capturing a color image, comprising:
a split optical system configured to split a light beam of an image from the imaging optical system into plural light beams, and form images again respectively on split image formation planes; and
optical filters equipped for the split plural light beams, wherein
a characteristic of at least one of the optical filters is a comb-shaped characteristic which divides, at wavelength regions, spectral sensitivity characteristic of primary colors of an image capturing system comprised in the camera section and capable of capturing a color image.

34. The adapter lens according to claim 33, further comprising:
a lens mount section to attach the adapter lens to the camera section;
a mount fixing section to which the imaging optical system can be attached directly; and
relay terminals which enable electric connection between the camera section and the imaging optical system, wherein
when the adapter lens is attached between the camera section and the imaging optical system, the imaging optical system and the camera section can communicate, between each other, information concerning the imaging optical system and a control signal.

35. The adapter lens according to claim 33, wherein at least one ND filter is used as the optical filters.

36. The adapter lens according to claim 33, wherein at least one wavelength tunable filter having an electrically controllable transmittance wavelength characteristic is used as the optical filters.

37. The adapter lens according to claim 33, wherein the optical filters are replaceable by a user.

38. The adapter lens according to claim 33, further comprising an information storage section configured to store information of the optical filters.

39. The adapter lens according to claim 38, wherein the information storage section further stores information concerning a spectral sensitivity characteristic of the imaging optical system, and diaphragms and focus positions of the imaging optical system and the split optical system.

40. The adapter lens according to claim 33, wherein
the split optical system has mirrors configured to reflect the split light beams, and reflection angle adjustment sections configured to adjust angles of the mirrors, and
angles of the mirrors are adjusted by the reflection angle adjustment sections to make the positions of images on the image formation planes adjustable.

41. The adapter lens according to claim 40, wherein the reflection angle adjustment sections are controllable by an electric signal.

42. The adapter lens according to claim 41, further comprising an information storage section configured to store information of the optical filters and states of the reflection angle adjustment sections.

43. The adapter lens according to claim 33, further comprising a terminal to which a sensor to detect an illumination condition at time of capturing an image can be connected.

44. The adapter lens according to claim 33, wherein
at least one wavelength tunable filter having an electrically controllable transmittance wavelength characteristic is used as the optical filters,
the split optical system has mirrors configured to reflect the split light beams, and a reflection angle adjustment section configured to adjust angles of the mirrors, positions of images being adjustable on the split image formation planes by adjusting the angles of the mirrors by the reflection angle adjustment section,
the adapter lens further comprises an image capturing mode setting section which can be operated by a user, and
based on an image capturing mode which the user sets by the image capturing mode setting section, the reflection angle adjustment section and the tunable filter are controlled to predetermined settings.
